(19) United States
(12) Patent Application Publication
(10) Pub. No.: US 2013/0246159 A1
(43) Pub. Date: Sep. 19, 2013

(54) METHODS FOR AND APPARATUS FOR AUTOMATED THIRD PARTY SALES INCENTIVES REDEEMABLE VIA A MOBILE DEVICE

(71) Applicant: Robert Davidson, New York, NY (US)

(72) Inventor: Robert Davidson, New York, NY (US)

(21) Appl. No.: 13/607,760

(22) Filed: Sep. 9, 2012

Related U.S. Application Data
(60) Provisional application No. 61/592,807, filed on Jan. 31, 2012.

(51) Int. Cl. G06Q 30/02

(52) U.S. Cl. CPC G06Q 30/0239
USPC 705/14.39

(57) ABSTRACT

The present invention provides methods and apparatus for providing and redeeming Purchase Incentive Artifacts via a mobile device and independent of a vendor point of sale system. The Purchase Incentive may be used to encourage a Purchaser to make a Purchase.

### CROSS REFERENCE TO RELATED APPLICATIONS

The present application claims priority to provisional patent application Ser. No. 61/592,807, filed, Jan. 31, 2012 and entitled, “Methods and Apparatus for Automated Third Party Sales”, the contents of which are relied upon and incorporated by reference.

### FIELD OF THE INVENTION

The present invention relates to automated methods and apparatus for providing incentives for a purchaser to complete a purchase at a vendor local to the purchaser. More specifically, a third party artifact is generated and transmitted which may be redeemed at location local to a purchaser and the third party receives remuneration based upon redemption of the coupon.

### BACKGROUND OF THE INVENTION

The marketplace today allows Purchasers to complete a purchase of a good or service in a variety of ways. Purchasers may patronize a local brick and mortar store or make a purchase via an online storefront. Many advantages exist for both venues. Online Products are often very competitive in price and allow a Purchaser to compare pricing and availability from vendors in many places throughout the world. In addition, online vendors are often not required to collect state sales tax, which provides an additional incentive for a Purchaser to purchase a Product online. Online shopping may also be conducted from almost anywhere, even from within the aisle of a store in which a Purchaser went to view a Product, or a Purchasers home.

Brick and mortar stores are therefore placed in the position of maintaining a brick and mortar storefront and stocking merchandise for a Purchaser to review and test the look and feel of the Product and then losing the sale to an online vendor due to price competition. The online vendor may often be more competitive in price since the online vendor does not have the requisite overhead associated with a brick and mortar storefront.

However, Local Vendors may offer other competing advantages. At a Local Vendor, a Purchaser may receive hands on coaching, service and support. In addition, a Local Vendor provides immediate access to the Product wherein the Purchaser receives it without delay. In addition, a Local Vendor typically does not include shipping costs, restocking fees, or other costs which an online vendor may charge. Finally, if so inclined, a Local Vendor may provide excellent customer service and create a relationship with a Purchaser wherein, by comparison an online experience is often impersonal.

The trend however is that Purchasers are increasingly making purchases online and Local Vendors lose sales. Loss of sales at local vendors may result in money and jobs exiting a local community. Therefore it would be helpful to provide a way for a Local Vendor to compete pricewise with an online vendor and also provide the inherent advantages of a local brick and mortar store.

### SUMMARY OF THE INVENTION

Accordingly, the present invention provides methods and apparatus for making local shopping more competitive with an online purchase experience. The present invention provides automated means for receiving a request from a Purchaser for a Purchase Incentive and automatically providing a Purchase Incentive to the Purchaser for a purchase at a vendor local to the Purchaser's location. The Purchase Incentive may be received independent of a Point of Sale system utilized by the Local Vendor.

Generally, the Purchase Incentive includes executable software operative via a processor included in a Purchaser's Mobile Device and in communication with an online server. A Purchaser's location may be determined for example via a Global Positioning Satellite (GPS) coordinates, an address input into a user interactive interface (UII), accelerometers used in conjunction with a GPS coordinate, or other coordinate system.

A database is maintained that includes data descriptive of vendors, including for example, data descriptive of the vendor name, vendor locations, items stocked by vendors and Purchase Incentives available for purchases made at the vendor.

Automated apparatus may receive information descriptive of one or more of: a Purchaser, a location of the Purchaser, a desired place of purchase for the Purchaser, and Purchase Priorities specific to the Purchaser. The automated apparatus provides one or more Third Party Purchase Incentives (TPPI), such as, for example, Third Party Discount Artifacts (TPDA) to the Purchaser. The TPDA may be utilized in conjunction with a Purchase from a vendor local to the Purchaser and the Purchaser may receive one or both of: a discount and remuneration based on completion of a Purchase of a Product or Service from a vendor local to the Purchaser.

In some embodiments, input may be received into a computer server via a distributed network and processed to generate an association of one or more Products or Services available from a specific Vendor local to a Purchaser. The computer server may make available to the Purchaser a TPDA for use with a purchase from a vendor identified as being local to the Purchaser.

A software engine included in the server may be used to match specific TPDAs with a Product a Purchaser has shown interest in, and a vendor local to the Purchaser that may supply the Product.

In some preferred embodiments, the server provides a Purchaser with guidance relating to a Purchase based upon the Purchaser Priorities or preferences, Products that are available that are local to the Purchaser and a value associated with available TPDAs. The server may thereby provide a recommendation on a best deal for the Purchase based upon the Purchaser's specific needs, preferences, location and local vendor Product availability.

A related aspect of the present invention provides methods and apparatus for generating and presenting an interface which facilitates a user in providing information to the server and receiving a TPDA based upon the provided information. The interface may be presented over a distributed network, such as the Internet, and may be accessed with any network access device, such as, by way of example: a personal computer, a laptop, a mobile phone, a tablet device, or other device with a user interface that facilitates access to Internet uniform resource locators.

In some respects, the present invention may be implemented to determine Purchaser Priorities, such as, for example, what matters most to a Purchaser, and correlate a Purchase Incentive type to the determination of which Product to purchase and which vendor to patronize, with what matters most to a user. In some preferred embodiments, steps directed to determining what matters most to a user are determined via question and answer input provided about the Purchaser.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 illustrates a functional block diagram of some aspects of the present invention.

FIG. 2 illustrates a flow diagram of method steps that may be used to implement some embodiments of the present invention.

FIG. 3 illustrates a block diagram of a purchase process that may be used to implement embodiments of the present invention.

FIG. 4 illustrates diagram of additional method steps that may be used to implement some embodiments of the present invention.

FIG. 5 illustrates diagram of additional method steps that may be used to implement some embodiments of the present invention.

FIG. 6 illustrates exemplary apparatus for implementing aspects of the present invention.

### DETAILED DESCRIPTION OF PREFERRED EMBODIMENTS

The present invention provides an automated system including methods and apparatus for providing a Purchase Incentive to a Purchaser on a Mobile Device wherein, in preferred embodiments, the Purchase Incentive may be redeemed irrespective of and independent of a Point of Sale device or system utilized by a Local Vendor. The independent nature of the present invention thereby enables ubiquitous vendor inclusion without the need for upgrades to Local Vendor POS hardware or software. The Purchase Incentive provides an incentive to a Purchaser to make a purchase at a vendor local to a Purchaser as compared to an online vendor. As presented herein, various embodiments of the present invention will be described, followed by some specific examples of various components that can be utilized to implement the embodiments.

Automated apparatus, such as a computer server running executable software determines which Products are most likely available to the Purchaser in an area generally local to the Purchaser. In some embodiments, a Purchaser may indicate a geographic range that may be considered local.

The automated apparatus is additionally functional to transmit to the Purchaser data descriptive of one or more merchants that are Local to the Purchaser. The automated apparatus also transmits an artifact which provides an incentive for the Purchaser to complete a purchase of the recommended Product from the Local merchant.

Glossary:

As used herein the following terms will have the following associated meaning:

“Buying Context” as referred to herein means circumstantial data related to a Purchase.

“Engine” as referred to herein means an apparatus including a processor that executes a software process to receive one or more inputs, process the inputs, and generate an output based upon the inputs. An engine may include one or more servers or be a generated on a server farm.

“Local” as referred to herein means in geographic proximity reasonable to travel to make a purchase based upon objective and subjective aspects of a purchase, which may include, for example a size of a purchase, the availability of a Product to be purchased and timing of when a Product is needed.

“Mobile Device” (which may also be referred as a smart phone, mobile phone, handheld device, handheld computer, or a handheld) as used herein shall mean a small handheld computing device, including a wireless communications capability, display screen and a user interactive apparatus such as a touch screen or a keyboard.

“Product” for the sake of simplicity in this discussion, as used herein a Product shall mean one or more of: a tangible item, machine or device; an intangible conveyance such as knowledge, know how or data stream; and a Service performed (as defined below).

“Purchaser” or multiple “Purchasers” as used herein shall mean one or more individuals, or a succinctly defined organization that makes or contemplates making a purchase.

“Purchase Incentive” as used herein shall mean one or more financial benefits conveyed upon a Purchaser based upon consummation of a purchase of a Product. A Purchase Incentive may include, for example, a discount on a purchase price, a credit issued to a charge account utilized to make a purchase, a refund of a sales tax, refund of a sales tax plus some predetermined amount, and refund of a sum certain.

“Service” as used herein shall mean an action performed at the request of a Purchaser.

“Third Party Purchase Incentive” (“TPPI”) as used herein shall mean a Purchase Incentive provided by a party other than a vendor with which the Purchase Incentive may be realized

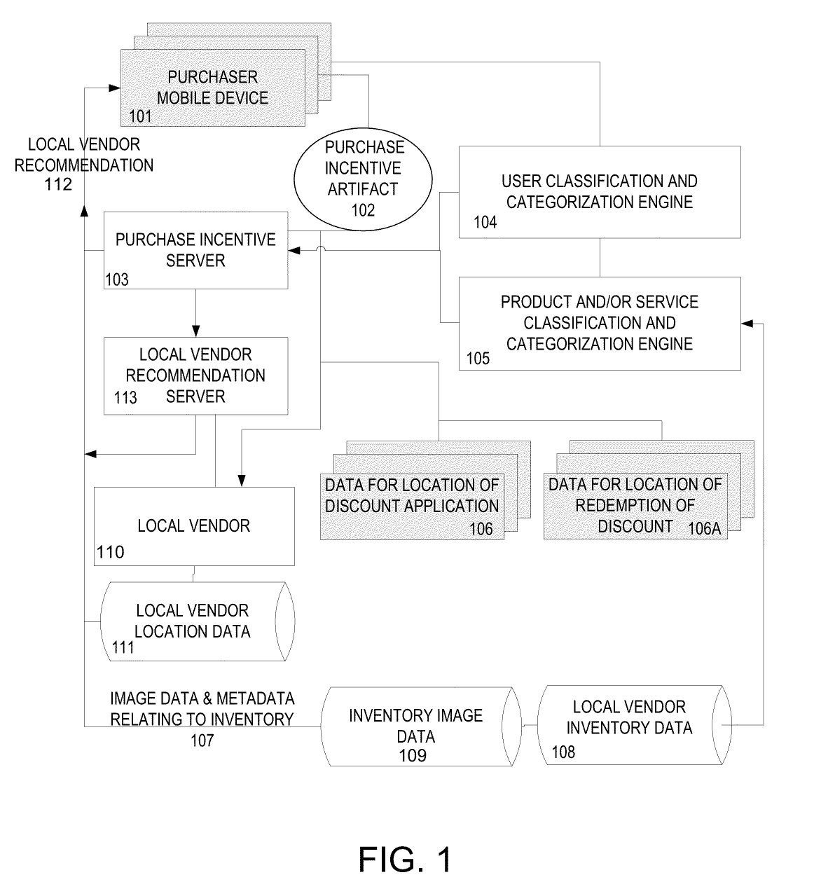

Referring now to FIG. 1, a functional block diagram illustrates aspects of the present invention wherein a Purchaser with a Purchaser Mobile Device 101 receives a Third Party Purchase Incentive Artifact 102 (TPPI 102) for use with a purchase consummated at the Local Vendor 110. The TPPI 102 may be redeemed via software executable via the Purchase Mobile Device 101, irrespective of a type of Point of Sale (POS) system being utilized by the Local Vendor 110.

According to the present invention, a Purchase Incentive Server 103 provides a Purchase Incentive Artifact 102 to a Purchaser Mobile Device 101. The Purchase Incentive Artifact 102 provides a financial incentive for consummating a purchase at a Local Vendor 110 as compared with an online vendor (not shown).

In some embodiments, a Purchaser may also receive one or more Local Vendor recommendations 114 indicating a convenient location where a Purchaser may purchase a Product. A Local Merchant Recommendation Server 103 may identify a Local Merchant 110 that is in geographic proximity to the Purchaser Mobile Device 101, wherein the Local Merchant 110 is identified as carrying a Product the Purchaser 101 has indicated the Purchaser desires to buy. Geographic proximity implies the Local Merchant is within a distance reasonable to travel to make a purchase based upon objective and subjective aspects of a purchase, which may include, for example a size of a purchase, the availability of a Product to be purchased and timing of when a Product is needed.

In addition, automated apparatus including the Purchase Incentive Server and the Local Vendor Server 113 may transmit data descriptive of a Purchase Incentive Artifact 102 which includes an incentive for the Purchaser 101 to complete a purchase with the Local Merchant.

A Purchase Incentive Artifact 102 may include for example, a virtual coupon that may be printed to become a physical coupon, or a virtual coupon displayed on a Smartphone or a personal digital assistant. As discussed further below, other Incentive Artifacts may include a bar code, a hash mark, a redemption code, an emblem mark or any other type of artifact that is capable of identifying an entity making the recommendation and hence referral.

In some embodiments the Incentive Artifact may include a discount entry field, or a redemption entry field, wherein the Purchaser may scan a barcode, hash or other device, or enter a store code into a field entry to be processed by a provider of the Product recommendation.

A Purchaser may receive a Local Vendor Recommendation 112 via a Purchaser Mobile Device 101.

In another aspect, in some embodiments, the present invention may access data such as, local vendor location data 111 and local vendor inventory data 108 to determine which storefront may have a particular Product in stock. In addition, some embodiments may include access image data 109 descriptive of a recommended Product. Image Data and metadata 107 descriptive of a Product may therefore be transmitted to a Purchaser Mobile Device 101 for consideration by the Purchaser.

In another aspect of the present invention, data related to users of a system for providing purchase incentive artifacts 102 may be collected and aggregated. A user classification and categorization engine 104 may be used to analyze and store data related to users of a system for providing purchase incentive artifacts 102 for local purchases.

Similarly, a Product and/or Service Classification and Categorization Engine 105 may be used to quantify and analyze data related to Products for which Purchase Incentive Artifacts are issued. The purchase related data may be stored and analyzed to understand usage trends and other data.

For example, data may be aggregated for all Purchase Incentive Artifacts requested and issued for one or more of, a given geographic area: a Product type, a specific Product, a brand of Product, a demographic associated with a Product, seasonal trends, location of a request for a Purchase Incentive Artifact, location of a Purchase of a Product in a transaction utilizing a Purchase Incentive Artifact, time of a request for a Purchase Incentive Artifact, time of a Purchase of a Product in a transaction utilizing a Purchase Incentive Artifact and other Purchase Incentive related data.

By way of illustrative example, as discussed more fully below, in some embodiments, the present invention may log a time and place that a user has requested a Purchase Incentive Artifact 102. For example, a geospatial recording from a Purchaser's Mobile Device may indicate that a Purchaser Mobile Device 101 is requesting a Purchase Incentive Artifact 102 from within the aisle of a brick and mortar store and also log a time of a request that a Purchaser Mobile Device 101 transmits a request for a Purchase Incentive Artifact 102.

In the discussion below, method steps that may be implemented in some embodiments are presented. The steps are not limited to any particular order unless other specified herein.

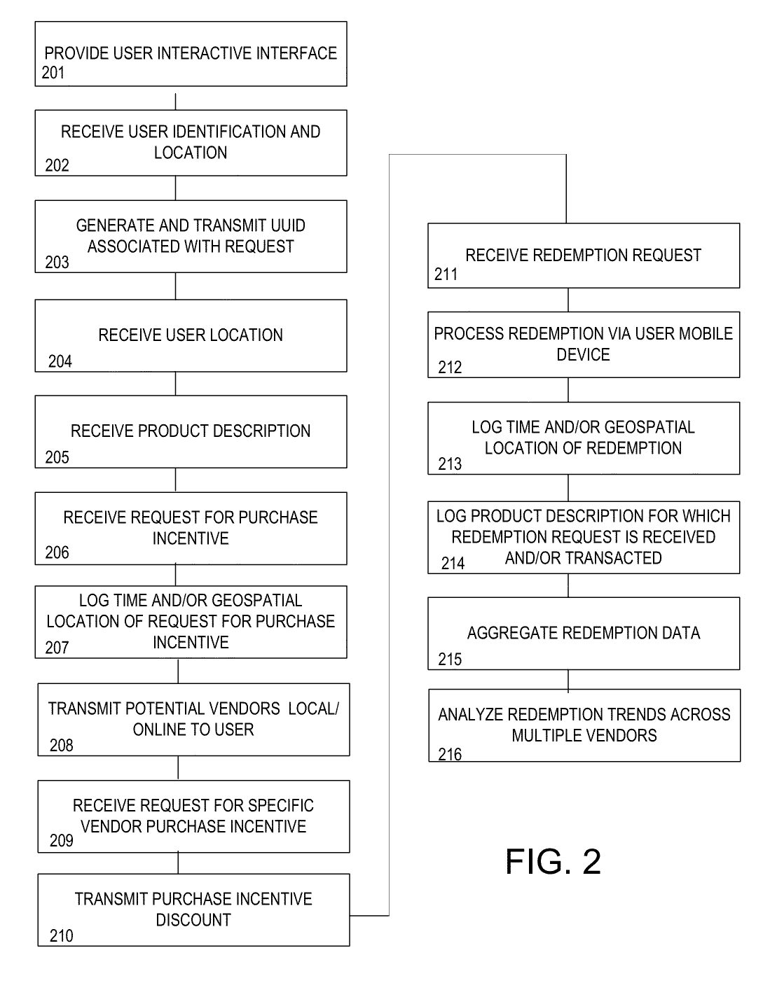

Referring now to FIG. 2, a flow diagram illustrates a method for an Engine including for example, one or more servers in logical communication with a distributed network, such as the Internet or another distributed digital network. The Engine provides a user, such as, for example, a Purchaser who is contemplating a purchase, with a user interactive interface on a Mobile Device. The purchase may be either for themselves or for a beneficiary. The user may access the provided interactive interface across a communications network, such as the Internet or via a mobile phone network, such as, for example, a 3G or 4G network or other cellular or WiFi network.

At 202, the Engine receives user identification and a location of the user. The user identification may include for example an account number or user login. The user location may include GPS data transmitted from a Purchaser Mobile Device. In some embodiments, GPS coordinates may be tracked until a Purchaser Mobile Device enters into a building wherein a GPS signal may no longer be available to the Purchaser Mobile Device. After the GPS signal is no longer available, accelerometers may be that are included within the Mobile Device to track movement within the building. Movement within the building, for example, may indicate an aisle in which a Purchaser transmits a request for a Purchase Incentive Artifact.

At 203, in some embodiments, each request will be associated with a unique identifier, such a universally unique identifier (UUID). The UUID may be generated by the Engine. At 204, The Engine may receive data indicative of a location from which a User Mobile Device is making a request for a Purchase Incentive Artifact. The location may be, for example, via GPS coordinates or User input.

At 205 the Engine may receive a description of a Product for which the Purchaser is requesting Purchase Incentive Artifact, and at 206 the Engine may receive a request for the Purchase Incentive Artifact. At 207, The Engine may log, or otherwise store digital data descriptive of, the time of receipt of the request for a Purchase Incentive Artifact and also a geospatial location from which the request is made. In some embodiments, the time and geospatial location are associated with a particular user making a request, in other embodiments, the time a geospatial location data is aggregated with data descriptive of other requests.

At 208, the Engine will transmit potential vendors for a Purchaser to make a Purchase from. In preferred embodiments, the Engine will transmit vendors that are local to a Purchaser and which carry the Product for which the Purchaser requested a Purchase Incentive Artifact. In some additional embodiments, the Engine will also transmit online vendors with which the Purchaser may compare multiple factors involved in making a purchase decision. The Engine may also transmit data descriptive of the multiple factors, including for example, data descriptive of shipping cost, time to ship and receive a product, tax due for each purchase scenario, warranty and return policies, etc. In addition, in some embodiments, a Purchaser may be presented with a choice of multiple alternative Purchase Incentives and choose an incentive most amenable to each Particular Purchaser. For example, one Purchase Incentive may include, an Engine sponsor paying sales tax for the Purchaser, another Purchase Incentive may include free extended warranty, still another incentive may include a sum certain credit to an account used to complete a Purchase.

At 209, the Engine may receive a request for a specific vendor Purchase Incentive and at 210, the Engine transmits the Purchase Incentive to the Mobile Device associated with the Purchaser. The transmission may be for example, via a distributed network, such as the Internet, or via a cellular network, such as via 3G, 4g or other cellular standard.

At 211, the Engine may receive a redemption request for a Purchase Incentive. According to the present invention, at 212 the redemption request may come from a transmission from the Mobile Device associated with the Purchaser. In such embodiments, the request may be generated and transmitted irrespective of a POS terminal used by a Vendor to consummate a purchase of a Product. By way of non-limiting example, the redemption request may include one or more of: a code, pattern, number or other mark from a POS receipt; a scan of a code, pattern, number or other mark on a sticker affixed on or near a POS terminal; a scan of a card or coupon provided by a POS operator, wherein the card or coupon may include a code, pattern, number or other mark, an identifier from a card processor indicating that a purchase was completed, or other data indicative of the completion of a purchase of a Product with which a Purchase Incentive is associated.

At 213, in some embodiments, the Engine may receive data descriptive of and log one or both of: a time and geospatial location of a redemption of a Purchase Incentive. In preferred embodiments, data descriptive of the time and geospatial location of a redemption of a Purchase Incentive are transmitted from a Purchase Mobile Device. The time may be generated by a processor tracking a local time on the Mobile Device. The geospatial location may be derived from a GPS function included in the Mobile Device.

At 214, the Engine may log, or otherwise store data descriptive of a Product for which one or both of: a redemption request is received and a redemption request is transacted.

At 215, data descriptive of almost any facet of a Purchase Incentive Artifact generation and redemption may be aggregated and at 216 the aggregated data may be analyzed.

According to the present invention, because a Mobile Device operated by a Purchaser may be used to both request a Purchase Incentive Artifact and to complete a Purchase Incentive transaction, unique data may be aggregated and analyzed. For example, the present invention allows for a time, date and place of a Purchase Incentive Artifact request, as well a Product type for which the Purchase Incentive would to be aggregated. In addition, the present invention teaches tracking whether a Purchase Incentive is redeemed, and if it is redeemed, a time, date and place of a Purchase Incentive Artifact redemption, as well a Product associated with the redemption to be aggregated. As such, analysis may include a time delta between a time of a Purchase Incentive Artifact request and redemption. Similarly analysis may include a distance delta between a geospatial location of a Purchase Incentive Artifact request and redemption.

Additional analysis may include Product types for which Purchase Incentives are redeemed, brands, vendors, purchase amounts, frequencies of redemptions, geographic areas, time of year, demographics associated with a geographic area in which redemptions are consummated, how redemptions track against economic data associated with a geographic area, and tracking Purchase Incentive Artifact request and redemption against almost any other data.

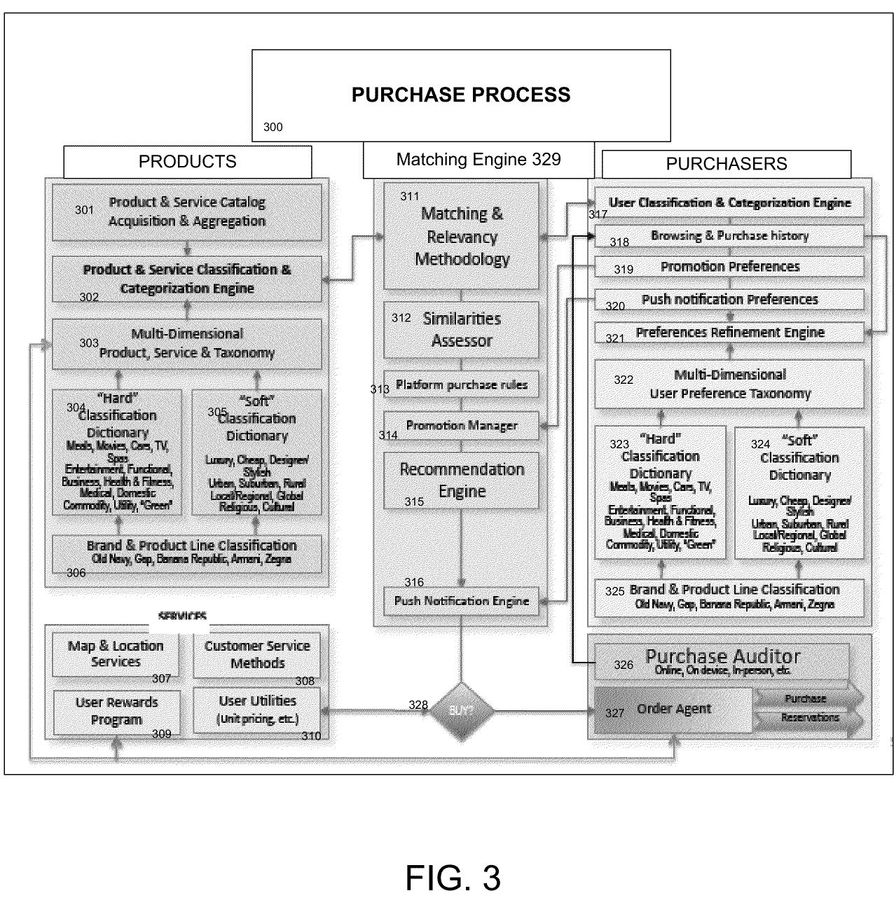

Referring now to FIG. 3, a process is presented according to some embodiments of the present invention. On a high level, the process includes method steps that may be implemented to practice novel aspects of the invention, including, for example, associating a time and place for requesting an incentive to make a purchase at a local level from a Local Vendor and consummating the transaction without a need to access a Local Vendor OS system At 301, data is aggregated which is descriptive of one or more Products. The data may include, for example, catalogs, whether physical or virtual with information quantifying aspects of a Product.

At 302, the aggregated data is input into a Product and Service Classification and Categorization Engine. In essence, the engine is a computerized apparatus with programmable code. The programmable code is executable upon demand to parse, sort and link various aspects of the aggregated data according to one or both of predefined taxonomies and relationships, and taxonomies and relationships “grown” as a result of data analysis. For example, it is within the scope of the present invention to associate product data with taxonomies and relationships previously encountered by a Product and Service Classification and Categorization Engine or have the engine create new taxonomies and relationships, based upon aggregated Product data received.

At 303, multi-dimensional data may therefore be generated with includes taxonomy tables relevant to a Product and which excludes taxonomy tables not relevant to a Product.

At 304, in some preferred embodiments, a Categorization and Classification Engine will allocate at least some of the aggregated data into a relatively objective “Hard” Classification Dictionary. A Hard classification may include, for example, one or more of: Meals, Movies, Television, Entertainment, Functional Business, Health, Fitness, Spas, Medical, Domestic, Foreign, and Commodity, environmentally friendly or “Green” or other relatively bright line test for inclusion or exclusion on an objective basis.

At 305, additionally, some preferred embodiments may include a Categorization and Classification Engine which allocates at least some of the aggregated data into a relatively subjective “Soft” Classification Dictionary. A Soft classification may include, for example, one or more of: luxury, cheap, designer, stylish, urban, suburban, rural, local, regional, global, religious, and cultural or other taxonomy or classification which is essentially relative to other taxonomies.

At 306, some exemplary embodiments may also include a recognition of a brand associated with a Product. The brand may include a trademark or other designation that associates a Product with a manufacturer or service provider. It is preferable that the brands also be associated with the taxonomies and classifications included in the hard Classification Dictionary and the Soft Classification Dictionary.

At 307-310, additional considerations that may be included in a presentation to a Purchaser of a Product suitable to the Purchaser. Additional considerations may include, for example, at 307, a map with an indication of where a Product or Service is available. In some embodiments, a location of a Product or Service may be shown relative to a location of an interested Purchaser. At 308, customer service methods, conditions, and terms may also be a considered taxonomy. At 309, a rewards program along with the conditions and terms of the program may be in included taxonomy. At 310 user utilities that may also be an included Taxonomy.

A matching engine 329 may include automated apparatus including a processor, a digital storage device and executable software stored on the digital storage and executable upon command to match Products which may include goods and services with Purchasers. The Matching Engine 329 may include multiple functionalities 311-316, including, for example a matching and relevancy methodology 311. A Similarities Assessor 312 may include executable code for associating Emotional Qualifiers with products and Emotional Motivators with users and base similarities of one or both based upon the associations. A Platform Purchase rules module 313 may be used to quantify the logistics of making a purchase for a particular platform on which the resent invention is implemented. For example, an online website may of a first set of Platform Purchase rules 313 and an in store kiosk may include a second set of Platform Purchase rules 313.

Considering now a Purchaser and taxonomies and data that may be input indicative of the Purchaser's Emotional Motivators, items 318-327 include various aspects of data that may be included by a user categorization and classification engine (sometimes referred to herein as “CC Engine”) 317 practicing the method steps of the present invention. At 318, the CC engine 318 may receive and process data indicative of one or both of a browsing history and a purchasing history of a Purchaser. A CC Engines may receive and process data indicative of one or both of: promotion preferences of a Purchaser 319; and push notification preferences of a Purchaser 320. At 321, a Preferences refinement engine may correlate various Purchaser preferences and generate preference trends for a Purchaser. The Purchaser trends may be included in a multi-dimensional Purchaser preference taxonomy or other user preference taxonomy, generated by a computerized device implementing the present invention.

At 317, data descriptive of a Purchaser or other user of a Purchase Incentive Artifact system may be placed into classifications and processed via a Categorization Engine for conducting analysis on the aggregated data. At 318, a browsing and/or purchase history may be associated with a particular user, or with a class of users, or with users in a specified geographic area, or during a specified time frame. At 319, advertising or Purchase Incentive promotions may be tracked, at 320, Push notifications may be tracked, at 321, preferences for a particular user, or group of users may also be ascertained from the aggregated data.

One or more multi-dimensional user preferences may be grouped according to taxonomies. The taxonomies may be based upon one or both of Hard Classifications and Soft Classifications. In addition, vendors, brands, and or products lines may be classified and analyzed according to Purchase Incentives requested and redeemed.

At 322, a multi-dimensional user preference taxonomy may be employed which includes input from a Product hard classifications dictionary 323 and a Product soft classifications dictionary 324. The Product hard classifications dictionary 323 may include, by way of non-limiting example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

The Product “Soft” Classification Dictionary 324 may generally include by way of non-limiting example, one or more of: luxury, cheap, designer, stylish, urban, suburban, rural, local, regional, global, religious, cultural or other taxonomy or classification which is essentially relative to other taxonomies.

At 325, Product and Brand classification may also include recognition of a brand associated with a Product. The brand may include, for example, a trademark, service mark, or other designation that associates a Product with a manufacturer or service provider. It is preferable that brands also be associated with taxonomies and classifications included in the hard Classification Dictionary and the Soft Classification Dictionary.

A Purchaser may make a decision to execute a “Buy” action 328 and make a purchase. An order agent 327 may be used to implement a purchase instruction associated with a Buy 328 action. As discussed further below, a Buy action 328 may be communicated to a computerized system via a user interactive device. The user interactive device may be any apparatus that is functional to interface between a human and a computerized system. The user interactive device may therefore include, for example, one or more of: a keyboard, mouse other pointing device, touchscreen, auditory voice command, neural interactive device or other apparatus.

The Order Agent 327 may essentially function as an interface between a user instruction and a purchase or reservation system or module. The Order Agent 327 will provide data to a purchase or reservation system or module sufficient for the purchase or reservation module to execute the Purchase instruction.

In another aspect of the present invention, a Purchase Auditor module 326 may track or audit purchases made by a Purchaser, or group of Purchasers (trending). The Purchase Auditor function may provide analysis of purchasing activity and plot any trends that may be present within data of a Purchaser or group of Purchaser's history. Accordingly, at a first given time period, a Purchaser may be primarily motivated by a first set of Motivators which are based upon a first set of Emotional Reasons. During a second time period, a prevalence of a second set of Emotional Reasons may emerge.

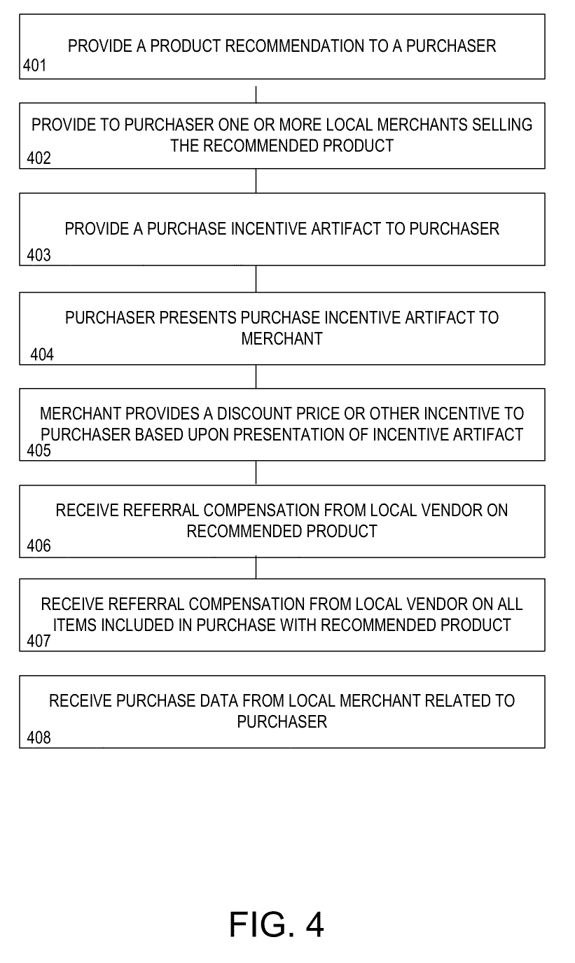

Referring now to FIG. 4, at 401 a server or other automated computer device, or online service, may provide functionality discussed herein. At 402, the server may provide to the Purchaser with data descriptive of one or more Local Merchants that sell the recommended Product. Additional data such as inventory data, product specifications, and images of the Product may also be included if desired. At 403, a Purchase Incentive Artifact may also be transmitted to the Purchaser. The Purchase Incentive Artifact may include, for example, a coupon, a bar code, a UUID, a purchase code, a hash mark or other artifact identifiable by the Local merchant.

At 404, the Purchaser may present the incentive artifact to the Local Merchant at the time of purchase; and, at 405, the Local Merchant may provide a discount price or other incentive to the Purchaser. Other incentives may include, for example, store credit, accessories, service warranty or other items of value.

At 406, a provider of the Purchase Incentive Artifact may receive referral compensation, from the Local Merchant. Referral compensation may include, for example, a currency amount based upon an amount of a purchase price for a recommended Product, such as for example between 1% and 15% of the purchase price of the recommended Product; a currency amount based upon an amount of a purchase price for a sale that includes the sale of a recommended Product and other items (at 407); a set referral fee, a scaled fee based upon an aggregate amount of sales for a time period, such as a monthly commission amount or other financial arrangement.

At 408, in some preferred embodiments, a provider of recommendations may receive purchase data from one or more Local Merchants related to purchases made by one or more Purchasers. Purchase data may include data on just recommended Products or on all items sold to the Purchaser. Similarly, Purchase data may include data based upon an aggregate of sales or sales related to specific Purchasers.

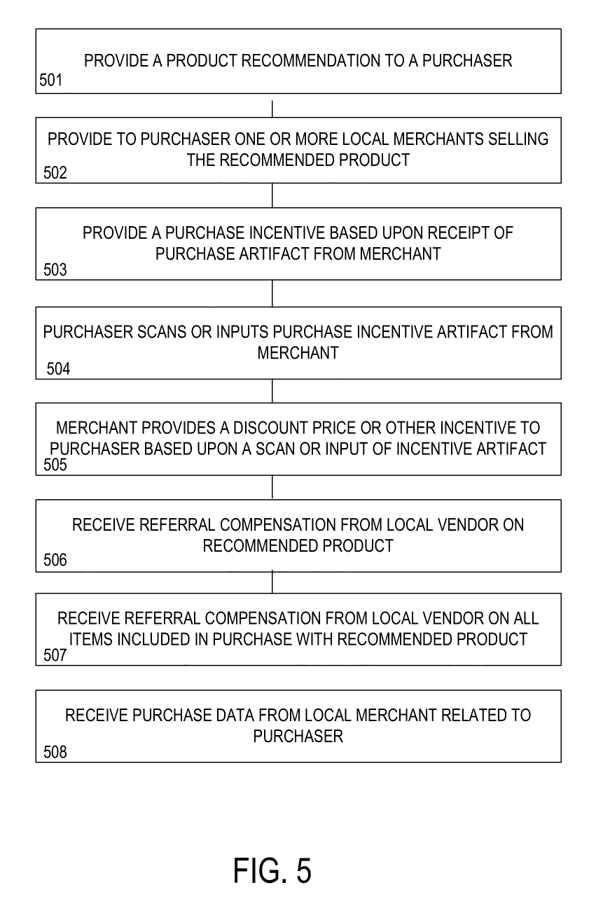

Referring now to FIG. 5 at 501, a server or other automated computer device, or online service, may provide to a Purchaser a Product recommendation. Product recommendations may include, for example, Products that are the subject of a promotion at the time of a Product inquiry, or a Product being actively marketed by a vendor local to the Purchaser.

At 502, the server may also provide to the Purchaser with data descriptive of one or more Local Merchants that sell the recommended Product. Additional data such as inventory data, product specifications, and images of the Product may also be included if desired. At 503, a Purchase incentive artifact may also be provided to the Purchaser by a Local Merchant. The Purchase incentive artifact may include, for example, a coupon, a bar code, a UUID, a purchase code, a hash mark or other artifact identifiable by the Local merchant.

At 504 the Purchaser may scan a purchase incentive artifact or input a code or otherwise quantify the Purchase incentive artifact and send a description of such artifact to the Product recommendation entity. At 505 the Merchant provides a discount price or other incentive to the Purchaser based upon the incentive artifact. At 506, the Product recommending entity may receive a referral compensation, as described above, for the Product Purchase referral, or on an entire Purchase (at 507).

At 508, in some preferred embodiments, a provider of recommendations may receive purchase data from one or more Local Merchants related to purchases made by one or more Purchasers. Purchase data may include data on just recommended Products or on all items sold to the Purchaser. Similarly, Purchase data may include data based upon an aggregate of sales or sales related to specific Purchasers.

A Purchaser may also scan a UPC code or another product identifying code and input the code into the system. The code may be accessed, for example while the Purchaser is shopping in a brick and mortar type store, or at some other time when the Purchaser is observing a Product, such as, for example, when examining a product purchased by a friend. The system may also provide a response indicating whether the scanned item is a recommended item.

A Purchaser may view details including functional ratings of Products being considered by the Purchaser. The details and ratings may be compiled from multiple sources, including, for example, manufacturer specifications, independent reviews, online blogs, government agencies, ratings entities, or other source.

A Purchaser may receive feedback related to Products of interest to the Purchaser. Feedback may include, for example, why a Product is recommended, or not recommended. Prices and purchasing deals for Products may be compared.

In some embodiments, a Purchaser may communicate with a store, such as a brick and mortar establishment via a communications network, such as the Internet. Communication with a local store may allow the Purchaser to check inventory of the store for a preferred Product. In addition, in some embodiments, a Purchaser may reserve or save a desired Product at the local store so that the Purchaser may go to the store and review the Product.

### Apparatus

The teachings of the present invention may be implemented with any apparatus capable of embodying the innovative concepts described herein. Image presentation may be accomplished via any multimedia type interface. Embodiments may therefore include a PC, handheld, game controller, PDA, cellular device, other multimedia device with user interactive controls, including, in some embodiments, voice activated interactive controls.

An exemplary user interactive interface may include multiple user interactive areas which may receive input from a user and provide one or both of human readable content or human recognizable images. Interactive areas may include, by way of non-limiting example, one or more of:

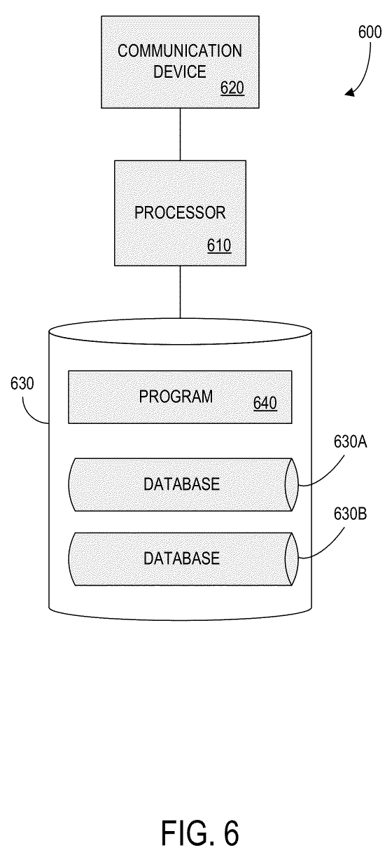

Referring now to FIG. 6, an illustration is provided with a controller 800 that may be embodied in one or more computer servers or communication network access devices and utilized to implement some embodiments of the present invention. A server may include, by way of example, a rack mounted server, stand alone server, a server farm or other embodiment of an automated apparatus for serving content on a communications network, such as the internet. Communications accessible devices may include, by way of example, a hand held device such as a cellular phone, a pad device, a personal computer, a server, a personal digital assistant, an electronic reader device or other programmable device.

The controller 600 comprises a processor unit 610, which may include one or more processors, coupled to a communication device 620 configured to communicate via a communication network, such as the Internet, or a other cellular based network such as a 3G or 4G network (not shown in FIG. 6). The communication device 620 may be used to communicate with a digital communications network, such as, for example, the Internet available via the Internet Protocol, or a cellular network such as 3G or 4G.

The processor 610 is also in communication with a storage device 630. The storage device 630 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 630 can store a program 640 for controlling the processor 610. The processor 610 performs instructions of the program 640, and thereby operates in accordance with the present invention. The processor 610 may also cause the communication device 620 to transmit information, including, in some instances, control commands to operate apparatus to implement the processes described above. The storage device 630 can additionally store related data in a database 630A and database 630B, as needed.

### Conclusion

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware can be implemented. Accordingly, other embodiments are within the scope of the following claims.

What is claimed is:

1. Apparatus for matching products and services with emotional motivators, the apparatus comprising:
a computerized server in logical communication with a digital communications network; and
executable software stored on the server and executable on demand, the software operative with the server to cause the apparatus to:
receive a Product description, identifying a Product;
receive a request for a Purchase Incentive related to the Product;
receive a location of a Purchaser associated with the Product description and the request for a Purchase Incentive related to the Product;
transmit data descriptive of one or more local vendors selling the recommended Product; and
transmit one or more Third Party Purchase Incentive Artifacts for the Product for use in conjunction with a purchase of the Product from the one or more of local vendor.

2. The apparatus of claim 1 wherein the software is additionally operative to transmit a specific local vendor at which the one or more Third Party Purchase Incentive Artifacts may be redeemed.

3. The apparatus of claim 2 wherein the software is additionally operative to transmit a link to a virtual point of purchase for one or more of the Products and transmit data descriptive of costs associated with a purchase of the Product from the virtual point of purchase.

4. The apparatus of claim 2 wherein the software is additionally operative to transmit a link to a physical point of purchase for the Product, wherein the physical point of purchase transmitted is based upon a geographical location of the physical point of purchase and the location of the Purchaser.

5. The apparatus of claim 1 wherein the software is additionally operative to receive data comprising a geospatial location from which the request for a Purchase Incentive related to the Product is received.

6. The apparatus of claim 1 wherein the software is additionally operative to:
receive a redemption request for redeeming a Third Party Purchase Incentive Artifact; and
complete the terms of the redemption of the Third Party Purchase Incentive Artifact via digital communication between devices comprising the server and the user mobile device.

7. The apparatus of claim 1 wherein the software is additionally operative to transmit data descriptive of a history of redemptions associated with a particular vendor.

8. The apparatus of claim 6 wherein the software is additionally operative to transmit a request for remuneration based upon the completion of the terms of the redemption of the Third Party Purchase Incentive Artifact.

9. The apparatus of claim 1 wherein the software is additionally operative to transmit data descriptive of emotional aggregated data comprising completion of terms of multiple redemptions of Third Party Purchase Incentive Artifacts.

10. The apparatus of claim 1 wherein the software is additionally operative to aggregate data comprising a history completion of terms of multiple redemptions of Third Party Purchase Incentive Artifacts by a particular Purchaser.

11. A method for matching products and services emotional motivators, the method comprising the steps of:
receiving into a computer server a Product description, identifying a Product;
receiving into the computer server a request for a Purchase Incentive related to the Product;
receiving into the computer server, a location of a Purchaser associated with the Product description and the request for a Purchase Incentive related to the Product;
transmitting from the computer server, data descriptive of one or more local vendors selling the recommended Product; and
transmitting from the computer server, one or more Third Party Purchase Incentive Artifacts for the Product for use in conjunction with a purchase of the Product from the one or more of local vendor.

12. The method of claim 11 wherein the method additionally comprises the step of transmitting a specific local vendor at which the one or more Third Party Purchase Incentive Artifacts may be redeemed.

13. The method of claim 12 wherein the method additionally comprises the steps of transmitting a link to a virtual point of purchase for one or more of the Products and transmitting data descriptive of costs associated with a purchase of the Product from the virtual point of purchase.

14. The method of claim 13 wherein the method additionally comprises the step of transmitting a link to a physical point of purchase for the Product, wherein the physical point of purchase transmitted is based upon a geographical location of the physical point of purchase and the location of the Purchaser.

15. The method of claim 14 wherein the method additionally comprises the step of receiving data comprising a geospatial location from which the request for a Purchase Incentive related to the Product is received.

16. The method of claim 15 wherein the method additionally comprises the steps of:
receiving a redemption request for redeeming a Third Party Purchase Incentive Artifact; and
completing the terms of the redemption of the Third Party Purchase Incentive Artifact via digital communication between devices comprising the server and the user mobile device.

17. The method of claim 16 wherein the method additionally comprises the step of transmitting data descriptive of a history of redemptions associated with a particular vendor.

18. The method of claim 17 wherein the method additionally comprises the step of transmitting a request for remuneration based upon the completion of the terms of the redemption of the Third Party Purchase Incentive Artifact.

19. The method of claim 18 wherein the method additionally comprises the step of transmitting data descriptive of emotional aggregated data comprising completion of terms of multiple redemptions of Third Party Purchase Incentive Artifacts.

20. The method of claim 19 wherein the method additionally comprises the step of aggregating data comprising a history completion of terms of multiple redemptions of Third Party Purchase Incentive Artifacts by a particular Purchaser.
